(19) United States
(12) Patent Application Publication
(10) Pub. No.: US 2001/0043012 A1
(43) Pub. Date: Nov. 22, 2001

(54) SAFE CIRCUIT OF CONNECTOR

(76) Inventors: FU-YUAN SHIH, TAOYUAN SHIEN (TW); YEN-CHUAN HSU, TAOYUAN SHIEN (TW); CHIA-HUNG HAIEN, TAOYUAN SHIEN (TW)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/345,057

(22) Filed: Jun. 30, 1999

(30) Foreign Application Priority Data
Apr. 2, 1999 (TW) 88101698

(51) Int. Cl. H02H 3/20

(52) U.S. Cl. 307/39; 307/116

(57) ABSTRACT

A circuit mounted in a housing of a connector for ensuring that the connector safely transmits an electric power provided by a first power source to a power-receiving device is provided. The circuit includes a sensor and a switch. The sensor is used for sensing a first electric signal released from the power-receiving device and a second electric signal from a second power source disposed in the connector respectively, and generating a first control signal and a second control signal correspondingly. The switch is used for switching on/off a communication channel between the first power source and the power-receiving device in response to the first control signal and the second control signal respectively.

### FIELD OF THE INVENTION

The present invention relates to a circuit mounted in a housing of a connector for ensuring that the connector safely transmits an electric power to a power-receiving device.

### BACKGROUND OF THE INVENTION

When a electric connector of a battery backup unit (BBU) or a power supply in a computer is electrically connected to a power-receiving device, such as a monitor, an electric power will be supplied from the BBU or the power supply to the monitor. However, the conventional electric connector is not safe enough because the conducting elements of the electric connector usually are exposed outside without any safety measures. As an example, if the wet hand of a child unwarily touches the conducting elements of the connector, this child will get an electric shock and probably get hurts.

Therefore, it is attempted by the applicant to provide a circuit adapted to be used in an electric connector so that the connector can safely supply an electric power.

### SUMMARY OF THE INVENTION

An object of the present invention is to provide a safe circuit of a connector for safely supplying an electric power to a power-receiving device. The electric power is provided by a first power source. The connector includes a housing, a sensor, and a switch. The sensor and the switch are both mounted in the housing. The sensor is used for sensing a first electric signal released from the power-receiving device and a second electric signal from a second power source disposed in the connector respectively, and generating a first control signal and a second control signal correspondingly. The switch is electrically connected to a first power source, the power-receiving device and the sensor respectively and is used for switching on/off a communication channel between the first power source and the power-receiving device in response to the first control signal and the second control signal respectively.

According to the present invention, the sensor receives the first electric signal from the power-receiving device and generates the first control signal to the switch correspondingly when the connector and the power-receiving device are connected. The first control signal is used for turning on the switch so that the electric power can be transmitted to the power-receiving device. The sensor receives the second electric signal from the second power source and generates the second control signal to the switch correspondingly when the power-receiving device is detached from the connector. The second control signal is used for turning off the switch so that the electric power transmitted to the power-receiving device can be interrupted.

In accordance with the present invention, the connector further includes a first conducting element for transmitting the first electric signal to the sensor when the connector is electrically connected to the power-receiving device. In addition, the connector further includes a second conducting element for transmitting the electric power to the power-receiving device when the connector is electrically connected to the power-receiving device. The second conducting element can include a plurality of pins.

According to the present invention, the first electric signal is a grounded voltage and the second electric signal is a low voltage of 5 V. The voltage of the second electric signal is higher than that of the first electric signal.

In accordance with the present invention, the sensor further includes a resistor electrically connected between the second power source and the power-receiving device. In addition, the sensor further includes an inverter electrically connected to the resistor, the switch, and the power-receiving device respectively for alternately inverting first electric signal and the second electric signal.

The present invention may best be understood through the following description with reference to the accompanying drawings, in which:

### BRIEF DESCRIPTION OF THE DRAWINGS

FIG. 1 is a circuit diagram of the safe connector according to the present invention.

### DETAILED DESCRIPTION OF THE PREFERRED EMBODIMENTS

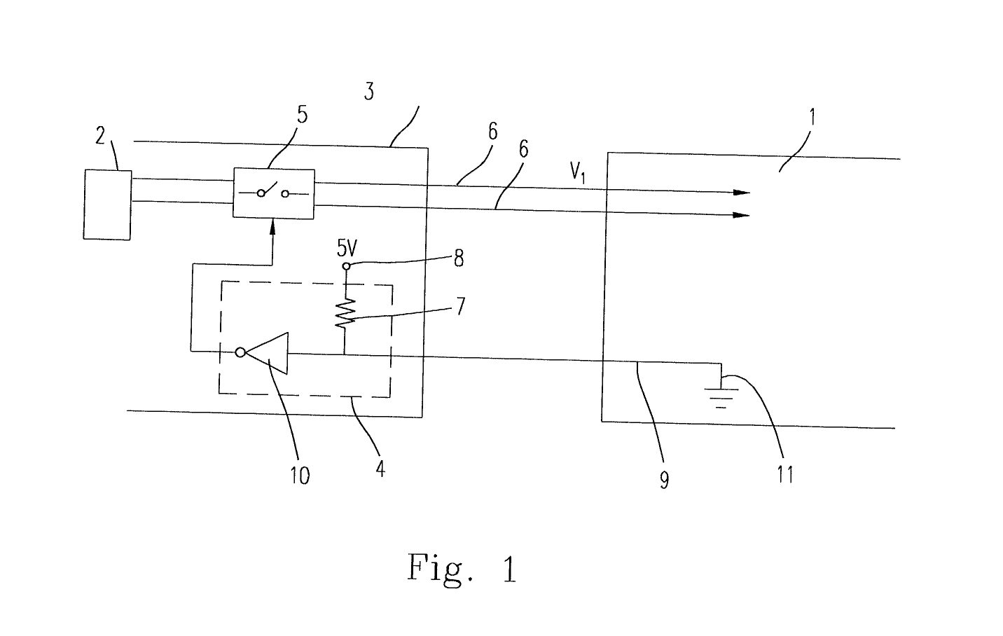

Please refer to FIG. 1. The safe connector of the present invention is electrically connected to a power-receiving device 1 and a first power source 2. The electric power provided from first power source 2 is delivered to the power-receiving device 1. The connector of the present invention includes a housing 3, a sensor 4, a switch 5, a first conducting element 9, and a second conducting element 6. The second conducting element 6 is used for transmitting the electric power from the first power source 2 to the power-receiving device 1 and can include a plurality of pins, such as two pins as shown in FIG. 1. The housing 3 is used for protecting the circuit inside the connector.

The sensor 4 includes a resistor 7. One end of the resistor 7 is electrically connected to a second power source 8. This second power source 8 is an inner power source inside the connector for providing a voltage, such as a 5 V voltage as shown in FIG. 1. The other end of the resistor 7 is electrically connected to the first conducting element 9. The first conducting element 9 is electrically connected to a grounded voltage 11 inside the power-receiving device 1.

The sensor 4 further includes an inverter 10 electrically connected to the resistor 7, the switch 5, and the power-receiving device 1 respectively for alternately inverting the grounded voltage 11 and the 5 V voltage 8. When the connector and the power-receiving device 1 are connected together, the sensor 4 will receive the grounded voltage 11 from the power-receiving device 1 and generate a first control signal to the switch 5 correspondingly. The first control signal is used for turning on the switch 5 so that the electric power can be transmitted to the power-receiving device 1 through the second conducting element 6.

When the power-receiving device 1 is detached from the conductor, the sensor 4 will receive the 5 V voltage from the second power source 8 and generate a second control signal to the switch 5 correspondingly. The second control signal is used for turning off the switch 5 so that the electric power transmitted to the power-receiving device 1 can be interrupted. Therefore, there is no electricity on the second conducting element 6. If someone carelessly touches it, he will not get any electric shock.

The first power source 2 of the present invention can be a direct-current power source or an alternating-current power source. The switch 5 can be a transistor switch, a silicon control rectifier (SCR), a mechanical switch, or a relay.

In conclusion, the connector of the present invention is very safe and is easily produced. The circuit inside the connector of the present invention can be applied to the conventional connector.

While the invention has been described in terms of what are presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A circuit mounted in a housing of a connector for safely supplying an electric power provided by a first power source to a power-receiving device, comprising:
a sensor mounted in said housing for sensing a first electric signal released from said power-receiving device and a second electric signal from a second power source disposed in said connector respectively, and generating a first control signal and a second control signal correspondingly; and
a switch mounted in said housing and electrically connected to said first power source, said power-receiving device and said sensor respectively for switching on/off a communication channel between said first power source and said power-receiving device in response to said first control signal and said second control signal respectively.

2. The circuit according to claim 1, wherein said sensor receives said first electric signal released from said power-receiving device and generates said first control signal correspondingly when said connector and said power-receiving device are connected.

3. The circuit according to claim 2, wherein said sensor transmits said first control signal to said switch for turning on said switch so that said electric power is transmitted to said power-receiving device.

4. The circuit according to claim 1, wherein said first electric signal is a grounded voltage.

5. The circuit according to claim 1, wherein said connector further includes a first conducting element for transmitting said first electric signal to said sensor when said connector is electrically connected to said power-receiving device.

6. The circuit according to claim 1, wherein said connector further includes a second conducting element electrically connected to said switch for transmitting said electric power to said power-receiving device when said connector is electrically connected to said power-receiving device.

7. The circuit according to claim 6, wherein said second conducting element includes a plurality of pins.

8. The circuit according to claim 1, wherein said sensor receives said second electric signal from said second power source and generates said second control signal correspondingly when said power-receiving device is detached from said connector.

9. The circuit according to claim 8, wherein said sensor transmits said second control signal to said switch for turning off said switch so that said electric power transmitted to said power-receiving device is interrupted.

10. The circuit according to claim 1, wherein said second electric signal is a low voltage of 5 V.

11. The circuit according to claim 10, wherein said voltage of said second electric signal is higher than that of said first electric signal.

12. The circuit according to claim 11, wherein said first electric signal is a grounded voltage.

13. The circuit according to claim 1, wherein said sensor further includes a resistor electrically connected between said second power source and said power-receiving device.

14. The circuit according to claim 13, wherein said sensor further includes an inverter electrically connected to said resistor, said switch, and said power-receiving device respectively for alternately inverting first electric signal and said second electric signal.

15. The circuit according to claim 1, wherein said switch is one selected from a group consisting of a transistor, a silicon control rectifier (SCR), and a relay.

16. A circuit mounted in a housing of a connector for safely supplying an electric power provided by a first power source to a power-receiving device, comprising:
a sensor mounted in said housing for sensing a first electric signal released from said power-receiving device and a second electric signal from a second power source disposed in said connector respectively, and generating a first control signal and a second control signal correspondingly; and
a switch mounted in said housing and electrically connected to said first power source, said power-receiving device and said sensor respectively for switching on/off a communication channel between said first power source and said power-receiving device in response to said first control signal and said second control signal respectively;
wherein said connector further comprises a first conducting element electrically connected between said sensor and said power-receiving device for transmitting said first electric signal to said sensor, and a second conducting element electrically connected between said switch and said power-receiving device for transmitting said electric power to said power-receiving device.

17. The circuit according to claim 16, wherein said sensor receives said first electric signal released from said power-receiving device and generates said first control signal correspondingly when said connector and said power-receiving device are connected.

18. The circuit according to claim 17, wherein said sensor transmits said first control signal to said switch for turning on said switch so that said electric power is transmitted to said power-receiving device.

19. The circuit according to claim 16, wherein said sensor receives said second electric signal from said second power source and generates said second control signal correspondingly when said power-receiving device is detached from said connector.

20. The circuit according to claim 19, wherein said sensor transmits said second control signal to said switch for turning off said switch so that said electric power transmitted to said power-receiving device is interrupted.
